(19) United States
(12) Patent Application Publication
(10) Pub. No.: US 2026/0056687 A1
(43) Pub. Date: Feb. 26, 2026

(54) SERVER APPARATUS THAT MANAGES IMAGE FORMING APPARATUS, COMPUTER-READABLE STORAGE MEDIUM, AND MANAGEMENT SYSTEM

(71) Applicant: CANON KABUSHIKI KAISHA, Tokyo (JP)

(72) Inventors: YUICHIRO HORI, Kanagawa (JP); KOSUKE OGAWA, Kanagawa (JP); NAOKI INOUE, Kanagawa (JP); TAKUYA HAYATO, Kanagawa (JP)

(21) Appl. No.: 19/378,584

(22) Filed: Nov. 4, 2025

Related U.S. Application Data
(63) Continuation of application No. PCT/JP2024/016872, filed on May 2, 2024.

(30) Foreign Application Priority Data
May 15, 2023 (JP) 2023-080368

(51) Int. Cl. G06F 3/12; G06K 15/02

(52) U.S. Cl. CPC G06F 3/121; G06F 3/1229; G06K 15/1823

(57) ABSTRACT

A server apparatus that manages an image forming apparatus that forms an image on sheets using a color material includes: one or more processors configured to, in a case where a remaining amount of the color material included in the image forming apparatus satisfies a first condition, determine that the color material is to be provided to a user of the image forming apparatus, and in a case where it has been determined that a first color material is to be provided to the user, determine a first consumption amount of the first color material until a first timing, and determine a first provision amount of the first color material to be provided to the user, based on the first consumption amount.

### CROSS-REFERENCE TO RELATED APPLICATIONS

This application is a Continuation of International Patent Application No. PCT/JP2024/016872, filed on May 2, 2024, which claims the benefit of Japanese Patent Application No. 2023-080368, filed on May 15, 2023, both of which are hereby incorporated by reference herein in their entirety.

### BACKGROUND

### Field of the Technology

The present disclosure relates to a technique to manage an image forming apparatus.

### Description of the Related Art

Japanese Patent Laid-Open No. 2022-006784 discloses a system for a subscription service on an image forming apparatus. In the following description, the subscription service is also simply referred to as “service”. According to Japanese Patent Laid-Open No. 2022-006784, a service provider provides a user with dedicated cartridges that are usable only during the use of the service. The cartridges contain color materials that are used by the image forming apparatus in image formation. Once the user has started to use the service, normal cartridges can no longer be used; once the user has stopped the use of the service, dedicated cartridges can no longer be used. In view of this, it is disclosed in Japanese Patent Laid-Open No. 2022-006784 that the service provider purchases normal cartridges used by the user at the start of the use of the service, and the service provider buys out dedicated cartridges used by the user when the use of the service is stopped.

### SUMMARY

According to a present disclosure, a server apparatus that manages an image forming apparatus that forms an image on sheets using a color material includes: one or more processors configured to, in a case where a remaining amount of the color material included in the image forming apparatus satisfies a first condition, determine that the color material is to be provided to a user of the image forming apparatus, and in a case where it has been determined that a first color material is to be provided to the user, determine a first consumption amount of the first color material until a first timing, and determine a first provision amount of the first color material to be provided to the user, based on the first consumption amount.

Features of the present disclosure will become apparent from the following description of embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain principles of the disclosure.

FIG. 1 is a schematic configuration diagram of an image forming apparatus according to some embodiments.

FIG. 2 is a configuration diagram of a development unit in the image forming apparatus according to some embodiments.

FIG. 3A is an explanatory diagram of a cartridge exchange procedure for the image forming apparatus according to some embodiments.

FIG. 3B is an explanatory diagram of the cartridge exchange procedure for the image forming apparatus according to some embodiments.

FIG. 3C is an explanatory diagram of the cartridge exchange procedure for the image forming apparatus according to some embodiments.

FIG. 4 is a configuration diagram of a management system according to some embodiments.

FIG. 5 is a configuration diagram of a management server according to some embodiments.

FIG. 6 is a diagram showing an exemplary screen displayed on a user terminal.

FIG. 7 is a diagram showing determination information according to some embodiments.

FIG. 8 is a sequence diagram of registration processing according to an embodiment.

FIG. 9 is a flowchart of processing for determining a provision amount of toner according to some embodiments.

FIG. 10A is an explanatory diagram of processing for determining provided toner according to some embodiments.

FIG. 10B is an explanatory diagram of processing for determining provided toner according to some embodiments.

FIG. 11 is a flowchart of processing for determining a provision amount of toner according to some embodiments.

FIG. 12A is a perspective diagram of an image forming apparatus according to some embodiments.

FIG. 12B is a perspective diagram of the image forming apparatus according to some embodiments.

FIG. 13 is an explanatory diagram of feeding of toner to the image forming apparatus according to some embodiments.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

Each of the following embodiments is applicable to an image forming apparatus, such as a copy device, a printer, a facsimile reception device, and a multi-functional peripheral. Also, each embodiment will be described below based on an image forming apparatus of an electrophotographic method, which uses toner as a color material. However, each of the following embodiments is applicable to any type of image forming apparatus that forms an image using other types of color materials, such as an inkjet printer that uses, for example, ink as a color material.

### First Embodiment

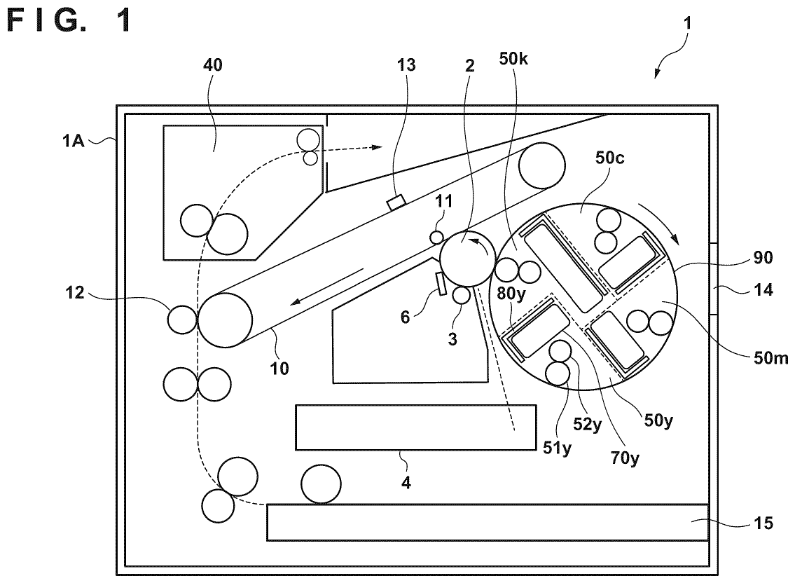

FIG. 1 is a schematic cross-sectional diagram of an image forming apparatus 1 that is to be managed by a management system according to the present embodiment. A photosensitive member 2 is driven to rotate in a counterclockwise direction of FIG. 1 at the time of image formation. A charging roller 3 charges a surface of the photosensitive member 2. An exposure apparatus 4 exposes the photosensitive member 2 to light based on image information, thereby forming an electrostatic latent image on the photosensitive member. A rotary 90, which includes development units 50y, 50m, 50c, and 50k, is configured to be rotatable in a clockwise direction of FIG. 1.

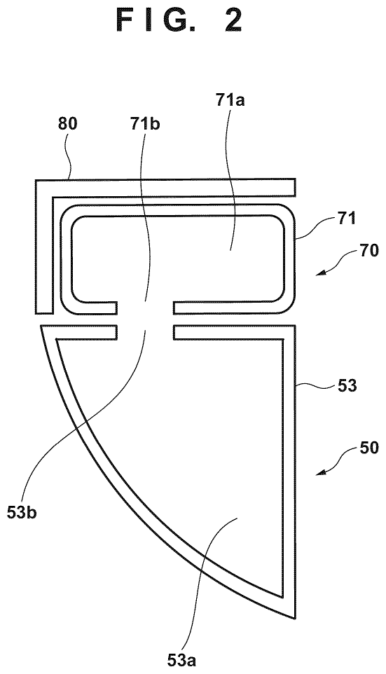

As the development units 50y, 50m, 50c, and 50k are configured in a similar manner, the configuration of the development unit 50y will be described below as a representative. A tray 80y is joined to the rotary 90, and is configured to be movable in a radial direction of the rotary 90. A cartridge 70y is attached to the tray 80y. The cartridge 70y is a container member that contains yellow toner. The cartridge 70y supplies toner to a toner container unit 53a (FIG. 2) of the development unit 50y. A supply roller 52y supplies toner in the toner container unit 53a to a development roller 51y. The development roller 51y develops the electrostatic latent image on the photosensitive member 2 using yellow toner when opposing the photosensitive member 2 as a result of rotation of the rotary 90, thereby forming a yellow toner image on the photosensitive member 2. Hereinafter, an orientation of the rotary 90 that causes the development roller 51y of the development unit 50y to oppose the photosensitive member 2 will be referred to as a yellow development orientation. A magenta development orientation, a cyan development orientation, and a black development orientation are defined also with regard to the development units 50m, 50c, and 50k, similarly to the development unit 50y. The magenta development orientation, the cyan development orientation, and the black development orientation are orientations of the rotary 90 that respectively enable the development units 50m, 50c, and 50k to develop electrostatic latent images on the photosensitive member 2.

As the development units 50y, 50m, 50c, and 50k are configured in a similar manner as stated earlier, the development units 50y, 50m, 50c, and 50k will also be collectively referred to as a development unit 50 below. Furthermore, discrete constituent elements of the development unit 50 will also be collectively referred to as a tray 80, a cartridge 70, a supply roller 52, and a development roller 51. Note that the size of the cartridge 70 need not be the same for each color. For example, while yellow, cyan, or magenta toner is used only in color printing, black toner is used in both of monochrome printing and color printing. Therefore, in general, the amount of consumption of black toner is larger than the amount of consumption of yellow, cyan, or magenta toner. Therefore, it is possible to adopt a configuration in which the cartridge 70 that contains black toner has a larger size and contains a larger amount of toner than the cartridge 70 that contains toner of another color.

A primary transfer roller 11 transfers toner images formed on the photosensitive member 2 to an intermediate transfer belt 10. A cleaning unit 6 removes toner that remains on the photosensitive member 2 without being transferred to the intermediate transfer belt 10 from the photosensitive member 2. An intermediate transfer belt 10 is driven to rotate in the clockwise direction of FIG. 1 at the time of image formation. In a case where a color image is formed, for example, a yellow toner image is formed on the photosensitive member 2 after the rotary 90 has been placed in the yellow development orientation, and this toner image is transferred to the intermediate transfer belt 10. Subsequently, a magenta toner image is formed on the photosensitive member 2 after the rotary 90 has been placed in the magenta development orientation. Note that the yellow toner image transferred to the intermediate transfer belt 10 is conveyed to the position opposing the photosensitive member 2 again with rotation of the intermediate transfer belt 10. The magenta toner image on the photosensitive member 2 is transferred so as to overlap this yellow toner image transferred to the intermediate transfer belt 10. Thereafter, in a similar manner, a cyan toner image and a black toner image formed on the photosensitive member 2 are sequentially transferred so as to overlap the toner images on the intermediate transfer belt. As a result, a color toner image is formed on the intermediate transfer belt 10.

A secondary transfer roller 12 transfers the color toner image formed on the intermediate transfer belt 10 to a sheet conveyed from a cassette 15. A cleaning apparatus 13 removes toner that remains on the intermediate transfer belt 10 without being transferred to the sheet from the intermediate transfer belt 10. Note that the secondary transfer roller 12 and the cleaning apparatus 13 are separated from the intermediate transfer belt 10 until the color toner image to be transferred to the sheet is formed on the intermediate transfer belt 10. In a case where a monochrome image is formed, a black toner image is formed on the photosensitive member 2 in the black development orientation, and this toner image is transferred to the intermediate transfer belt 10 and then further to a sheet.

A fixing apparatus 40 applies heat and pressure to a sheet to which toner images have been transferred, thereby fixing the toner images on the sheet. After the toner images have been fixed, the sheet is discharged to the outside of the image forming apparatus 1. A door 14 for exchanging a cartridge 70 is provided on a side of a body 1A of the image forming apparatus 1 that opposes the rotary 90.

FIG. 2 is an explanatory diagram of a configuration of a development unit 50. Note that in FIG. 2, a supply roller 52 and a development roller 51 are omitted to simplify the diagram. The development unit 50 includes a frame body 53. An internal space of the frame body 53 constitutes a toner container unit 53a. A supply roller 52 and a development roller 51 are provided in the toner container unit 53a. The frame body 53 is provided with an opening 53b for feeding toner from the cartridge 70 to the toner container unit 53a. The inside of a frame body 71 of the cartridge 70 constitutes a toner container unit 71a that contains toner. The frame body 71 is provided with an opening 71b for feeding toner to the toner container unit 53a. The development unit 50 is configured so that the opening 71b and the opening 53b oppose each other in a state where the cartridge 70 has been attached to the development unit 50. Toner is fed from the cartridge 70 to the toner container unit 53a when the toner container unit 53a is lower in position than the cartridge 70.

Note that it is possible to adopt a configuration in which the cartridge 70 is provided with a sealing member that covers the opening 71b. Similarly, it is possible to adopt a configuration in which the frame body 53 is provided with a sealing member that covers the opening 53b. By providing the sealing members for the opening 71b and the opening 53b, an outflow of toner is suppressed in a state where the cartridge 70 has not been attached to the development unit 50.

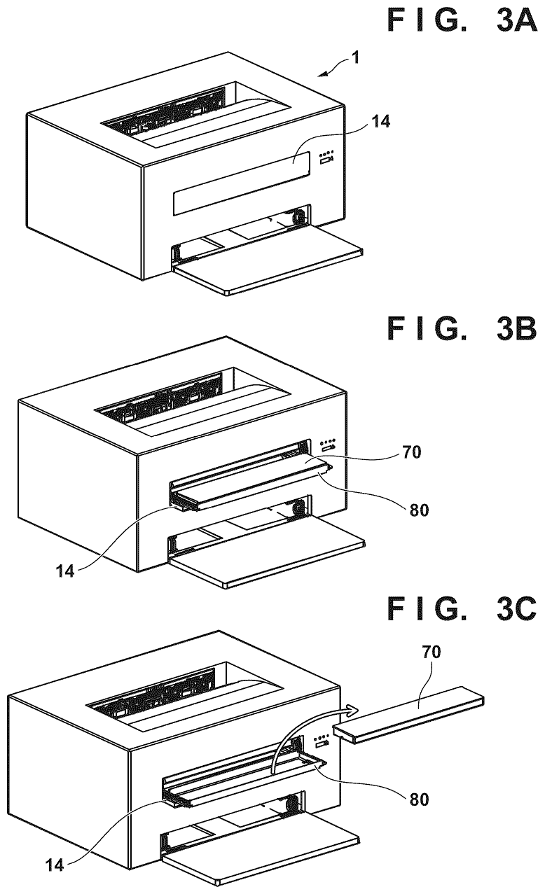

FIG. 3A to FIG. 3C are explanatory diagrams of processing for exchanging a cartridge 70. FIG. 3A shows the image forming apparatus 1 during an image forming operation or in a standby state in which the door 14 is in a closed state. A control unit of the image forming apparatus 1 is configured to be capable of detecting the remaining amount of toner contained in a cartridge 70 or a toner container unit 53a with use of a non-illustrated remaining amount detection mechanism. Also, the control unit is configured to be capable of, based on the result of detection of the remaining amount of toner, providing a user with a notification indicating that the remaining amount of toner has reached a predetermined value that is an indication of exchange, and that a cartridge 70 needs to be exchanged, for each cartridge 70. When exchanging a cartridge 70 based on this notification, the user issues an instruction for a cartridge exchange operation to the control unit via an input interface, such as an operation panel.

In response to the instruction for the cartridge exchange operation, the control unit causes the cartridge 70 to be exchanged to oppose the door 14 by rotating the rotary 90. Subsequently, the control unit causes a tray 80 that supports the cartridge 70 to be exchanged in a radial direction, that is to say, a direction toward the door 14. As a result, as shown in FIG. 3B, the door 14 is pushed by the tray 80 and placed in an open state, and the tray 80 and the cartridge 70 supported by the tray 80 project to the outside of the image forming apparatus 1. This enables the user to exchange the cartridge 70 as shown in FIG. 3C.

Note that the control unit can be configured so as not to accept the instruction for the cartridge exchange operation until the remaining amount of toner becomes equal to or smaller than the predetermined value. Alternatively, it is possible to adopt a configuration in which a cartridge 70 is provided with an attachment/detachment lock mechanism, and the control unit controls the attachment/detachment lock mechanism so that the cartridge 70 cannot be exchanged until the remaining amount of toner becomes equal to or smaller than the predetermined value. Note that the predetermined value can be 0. This configuration can reduce the amount of toner that is discarded without being consumed.

### <Management System>

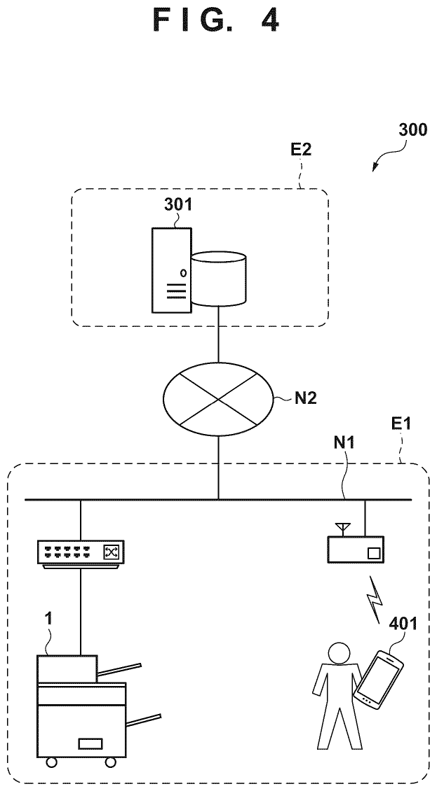

FIG. 4 is a configuration diagram of a management system 300 according to the present embodiment. The management system 300 includes the image forming apparatus 1, a management server 301, and a user terminal 401. The management server 301 is administered by, for example, a business operator that provides a subscription service (a service provider), or a business operator under management of the service provider. The image forming apparatus 1 is an apparatus that is used by a user who has signed a contract for using the service (hereinafter, a service contract) with the service provider, and the user terminal 401 is an information terminal that is used by this user.

The image forming apparatus 1 is placed in a user environment E1 in which the user is present. The image forming apparatus 1 and the user terminal 401 are connected to a local network N1. The local network N1 can be, for example, a local area network (LAN). The user uses the image forming apparatus 1 in the user environment E1. As stated earlier, the image forming apparatus 1 forms an image on a sheet using toner, which is a color material.

The management server 301 is placed in an environment (a remote environment E2) that is remote from the environment in which the image forming apparatus 1 is placed (the user environment E1). The remote environment E2 is connected to the local network N1 via an external network N2. The external network N2 can be, for example, the Internet or a virtual private network (VPN). Each of the local network N1 and the external network N2 can include arbitrary types of network apparatuses, such as routers, switches, gateways, wireless access points, and base stations. Also, each of the local network N1 and the external network N2 can include an arbitrary number of network apparatuses.

In the present embodiment, the management server 301 is a server apparatus that manages the image forming apparatus 1. For example, the management server 301 manages the number of printed sheets (the number of pages), which is the number of sheets on which image formation has been performed in the image forming apparatus 1, user account information, and the like. The management server 301 may be mounted as an application server, a database server, or a cloud server with use of, for example, a general-purpose computer.

The user terminal 401 is a terminal apparatus that provides the user with a user interface for assisting a management function of the management server 301. The user terminal 401 can be a general-purpose terminal apparatus, such as a smartphone, a mobile telephone, a personal computer (PC), and a personal digital assistant (PDA). The image forming apparatus 1, too, can provide the user interface to the user.

Note that the functions of the management server 301 may be provided by a single apparatus, or may be provided by a plurality of physically independent apparatuses cooperating with one another. Furthermore, a part of a database that is described as being held in the management server 301 may be held in an external apparatus that is independent of the management server 301 (e.g., another database server).

### <Configuration of Management Server>

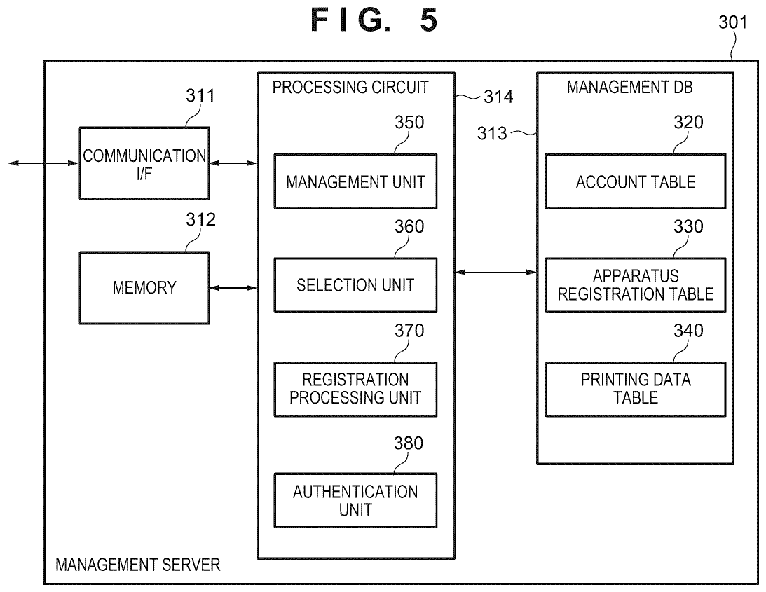

FIG. 5 is a block diagram showing an exemplary configuration of the management server 301 according to the present embodiment. A communication I/F 311 is a communication interface for communication via the external network N2. The communication I/F 311 may be a wired communication interface or a wireless communication interface. A memory 312 can include arbitrary types of storage mediums, such as a semiconductor memory like a read-only memory (ROM) or a random-access memory (RAM), an optical disc, and a magnetic disk. The memory 312 can include a non-transitory computer-readable storage medium. The memory 312 stores one or more computer programs that are executed by a processing circuit 314, and various types of data, such as data used by the processing circuit 314.

A management database (DB) 313 includes an account table 320, an apparatus registration table 330, and a printing data table 340. In the subscription service of the present embodiment, in a case where the number of sheets printed by an image forming apparatus 1 in a predetermined period (e.g., one month) is equal to or smaller than an upper limit value stipulated by the service contract, a user is charged a certain fee regardless of the number of printed sheets. The following information, which is included in each table inside the management DB 313, is associated with the service contract.

An account table 320 is a table that holds information related to an account of a user. The account table 320 can include, for example, one or more of the following items.
“User ID”. “Password”
“Name”
“E-mail address”
“Postal address”
“The number of sheets contracted for color”
“The number of sheets contracted for monochrome”. “Payment method”
“Serial number (serial No.)”
“Contract period”
“Remaining period of contract”

The “user ID” is identification information for uniquely identifying an account of each user. The “password” is used in user authentication when a user logs into the system. The “name” indicates a user name of each account. The user name is displayed, for example on a screen after the login. The “e-mail address” can be used when the system provides each user with various notifications by electronic mail. The “postal address” is used as, for example, a destination to which cartridges 70 are delivered. The “number of sheets contracted for color” indicates an upper limit value of the number of printable sheets in color printing at a fixed rate during the predetermined period. The “number of sheets contracted for monochrome” indicates an upper limit value of the number of printable sheets in monochrome printing at a fixed rate during the predetermined period. In the following description, the number of sheets contracted for color and the number of sheets contracted for monochrome will be collectively referred to as the number of contracted sheets. The “payment method” indicates a payment method for the price of the service. The “serial number” indicates identification information that can be used as a search key for specifying a user ID. The “contract period” indicates a period of contract of the service, and the “remaining period of contract” indicates a period of contract remaining at that point.

The apparatus registration table 330 is a table that holds information related to an image forming apparatus 1 used by each user. The apparatus registration table 330 can include, for example, one or more of the following items.
“Owner”
“Apparatus ID”
“Date of registration”
“Status”

The “owner” indicates an account of a user who owns or uses each image forming apparatus 1 with use of a “user ID” registered with the account table 320. The “apparatus ID” is identification information for uniquely identifying an image forming apparatus 1. The pair of “owner” and “apparatus ID” indicates association between an account of a user and an image forming apparatus 1 used by this user. Two or more image forming apparatuses can be associated with one user account. The “data of registration” indicates a date on which the “apparatus ID” of an image forming apparatus 1 was registered with the apparatus registration table 330. The “status” indicates a status related to a verification of whether an image forming apparatus 1 is actually placed in a user environment E1 of the “owner”. At the time of initial registration of the “apparatus ID”, the “status” can indicate “unverified”; upon completion of the verification, the status can be changed to “verified”.

The printing data table 340 is a table that holds data related to printing. The printing data table 340 can include, for example, one or more of the following items.
“The number of pages contracted in the present month (monochrome)”
“The number of pages contracted in the present month (color)”
“The number of pages already used (monochrome)”
“The number of pages already used (color)”
“The number of usable pages (monochrome)”
“The number of usable pages (color)”
“Cartridge information”

The “number of pages contracted in the present month (monochrome)” indicates the same information as the “number of sheets contracted for monochrome” in the account table 320. Note that in the following description, the predetermined period is assumed to be “one month”. The “number of pages contracted in the present month (color)” indicates the same information as the “number of sheets contracted for color” in the account table 320. The “number of pages already used (monochrome)” and the “number of pages already used (color)” respectively indicate the number of sheets already printed in monochrome and the number of sheets already printed in color in the current month. The “number of usable pages (monochrome)” and the “number of usable pages (color)” respectively indicate the number of sheets that can be printed in monochrome and the number of sheets that can be printed in color within the range of the fixed rate by the last date of the current month. The “cartridge information” indicates such information as types, identification numbers, the remaining amounts of toners, and the amounts of used toners of cartridges 70 used in an image forming apparatus 1.

The processing circuit 314 can be, for example, a central processing unit (CPU). The processing circuit 314 provides the functions included in the management server 301 by executing a computer program stored in the memory 312. More specifically, as shown in FIG. 5, the processing circuit 314 can function as a management unit 350, a selection unit 360, a registration processing unit 370, and an authentication unit 380.

The management unit 350 manages processing in the selection unit 360, the registration processing unit 370, and the authentication unit 380, and also executes processing related to communication with the user terminal 401 and the image forming apparatus 1. Also, the management unit 350 functions as a first determination unit that determines whether it is necessary to provide a user with toner, that is to say, a cartridge 70. The registration processing unit 370 manages registration and update of data with respect to the management DB 313. For example, the management unit 350 can cause the user terminal 401 to display a screen for accepting an input of account information to be registered with the account table 320. In this case, the management unit 350 receives the input account information from the user terminal 401 via the communication I/F 311. The registration processing unit 370 can register the received account information with the account table 320. Also, the management unit 350 can cause the user terminal 401 to display a screen for accepting an input of apparatus information related to an image forming apparatus 1 possessed by each user. In this case, the management unit 350 receives the input apparatus information from the user terminal 401 via the communication I/F 311. The registration processing unit 370 can register the received apparatus information with the apparatus registration table 330. Furthermore, the management unit 350 repeatedly obtains information related to the number of sheets already printed and the remaining toner amounts from an image forming apparatus 1. The registration processing unit 370 updates the printing data table 340 based on the information related to the number of sheets already printed and the remaining toner amounts.

The authentication unit 380 performs login authentication for a user to log into the management system 300. For example, the management unit 350 causes the user terminal 401 to display a login screen for accepting inputs of a user ID and a password, and receives the user ID and the password from the user terminal 401 via the communication I/F 311. The authentication unit 380 performs user authentication using the user ID and password that have been received, and the user IDs and passwords stored in the account table 320.

The selection unit 360 functions as a second determination unit that selects or determines a type of a cartridge 70 to be provided to the user in a case where the management unit 350 has determined that the cartridge 70 is to be provided to a user. The registration processing unit 370 registers cartridge information related to the cartridge 70 selected by the selection unit 360 with the printing data table 340. Types of cartridges 70 and a method of selecting a type will be described later.

An input screen that is displayed on the user terminal 401 by the processing circuit 314 can be provided in any format, such as a web page, an input form, an application screen, and the like. For example, the user terminal 401 can accept an input of apparatus information during a period in which a user is logging in the management system 300 (management server 301) after succeeding in the user authentication that uses the user IDs and passwords stored in the account table 320.

### <Example of GUI>

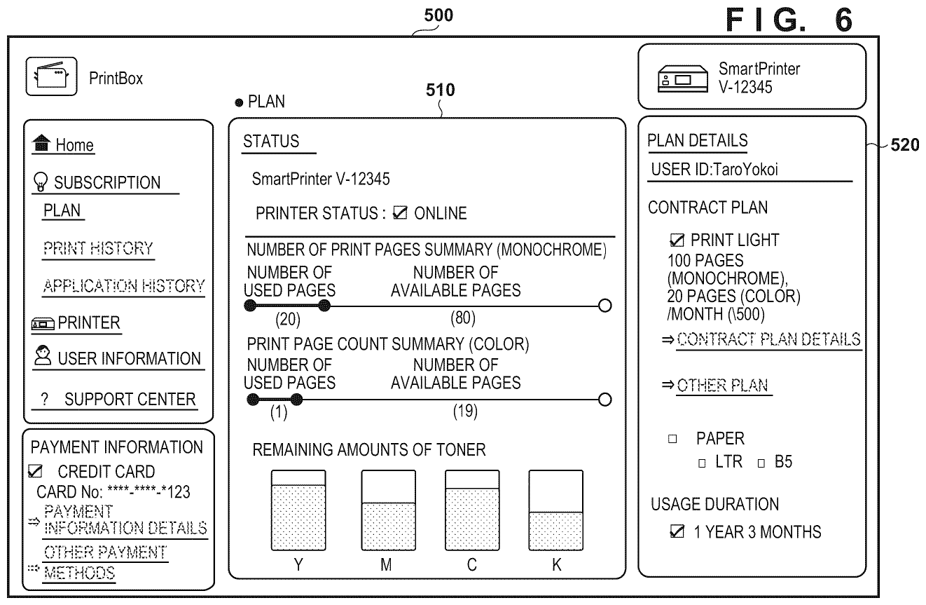

FIG. 6 shows a screen 500 as an example of a graphical user interface (GUI) that is provided by the management server 301 and displayed on a display unit of the user terminal 401. A screen 500 is displayed on the display unit of the user terminal 401 as a result of a user (contractor user) logging into the management system 300 using the user terminal 401. The screen 500 displays information held in the management DB 313 of the management server 301. The information displayed on the screen 500 includes the content of the service contract.

The screen 500 includes regions 510 and 520. The region 510 displays information of items included in the printing data table 340. The region 520 displays information of items included in the account table 320 and the apparatus registration table 330. The screen 500 is configured to enable the user to confirm information managed by the management server 301 via this screen. Furthermore, the screen 500 is configured to enable the user to change the content of the service contract (a contracted plan) via this screen.

The screen 500 indicates that, with the current contracted plan, the number of sheets contracted for monochrome printing is 100 sheets per month, and the number of sheets contracted for color printing is 20 sheets per month. Furthermore, the screen 500 also indicates that 20 sheets and one sheet have already been printed in monochrome and in color, respectively, and that the remaining number of sheets to be printed in monochrome and the remaining number of sheets to be printed in color are 80 sheets and 19 sheets, respectively. Moreover, the screen 500 also indicates the remaining toner amounts in cartridges 70 of respective colors.

The service provider provides cartridges 70 to the user based on the service contract. Specifically, the service provider provides first cartridges 70 upon the service contract. Thereafter, the management server 301 obtains information related to the remaining toner amounts in an image forming apparatus 1 from the image forming apparatus 1, and provides an exchange cartridge 70 to the user when a remaining toner amount satisfies a provision condition for providing toner. In the following description, a cartridge 70 that is provided to the user at first at the time of the service contract will be referred to as a starter cartridge, and a cartridge 70 that is thereafter provided for exchange will be referred to as an exchange cartridge.

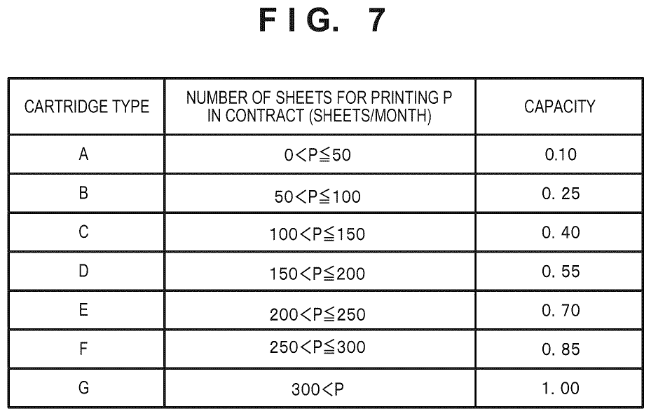

In the present embodiment, the selection unit 360 decides a type of a starter cartridge of each color based on the service contract. A type of a cartridge 70 is distinguished based on the amount of toner contained in this cartridge 70. As an example, it is assumed that cartridges 70 of seven types, namely type A to type G, are used as shown in FIG. 7. In FIG. 7, a capacity is the amount of toner (the amount of color material) contained in a cartridge 70, and is indicated by a relative value relative to 1, which represents an amount that can be contained in the cartridge 70 (a maximum amount that can be contained therein). As shown in FIG. 7, a capacity of each type of cartridge 70 is equal to or smaller than the amount that can contained in the cartridge 70. For example, a cartridge 70 of type G contains the maximum amount of toner, whereas a cartridge 70 of type A contains toner that is 1/10 of toner in the cartridge G.

The memory 312 of the management server 301 stores determination information indicating a relationship between the number of sheets for printing under the service contract (per month) and cartridge types as shown in FIG. 7. Note that the determination information shown in FIG. 7 is generated per “contract period” of the service contract. The “contract period” is stored in the account table 320. For example, in a case where the “contract period” of the user is two years, the management server 301 decides the types of starter cartridges with use of determination information associated with a contract period of two years. For example, assume that the “number of sheets contracted for color” and the “number of sheets contracted for monochrome” of the user are respectively 20 sheets and 100 sheets as shown in FIG. 6, the “contract period” is two years, and FIG. 7 shows determination information for a contract period of two years.

In this case, with regard to color printing, P=20, and thus the type of cartridges 70 is A. Therefore, yellow, cyan, and magenta starter cartridges, which are used only in color printing, are of type A. On the other hand, with regard to black, as black is used in both of color printing and monochrome printing, the value of P is 20+100, namely 120, and a type C applies. Therefore, a black starter cartridge is of type C. The service provider executes processing for delivering, to the user, a starter cartridge of the type determined by the selection unit 360 for each color. Also, the registration processing unit 370 registers information of the starter cartridges of the types determined by the selection unit 360 with the printing data table 340.

Note that in the present embodiment, one piece of determination information is used to decide the types of cartridges 70 of respective colors. However, for example, it is possible to adopt a configuration in which determination information for deciding a type of a black cartridge 70 is different from determination information for deciding a type of color cartridges 70. Furthermore, it is also possible for pieces of determination information for deciding the types of cartridges 70 of four colors to be different from one another. Moreover, although there are seven types of cartridges 70, namely type A to type G, in the present embodiment, the number of types can be any number equal to or larger than two. In addition, the number of types of a cartridge 70 may not be the same among discrete colors.

Determination information is set so that the number of times exchange cartridges are provided (the number of times they are delivered) becomes small, and so that the amounts of toners remaining in cartridges 70 become small at the end of the contract. That is to say, determination information is generated based on estimated values of the amounts of consumed toners in the contract period that are determined based on a combination of the contract period and the number of contracted sheets. For example, in the aforementioned example, the type of color starter cartridges is A, and the type of a black starter cartridge is C. This means that the estimated value of the amount of color toner consumed in a contract period of two years is closest to the amount of toner of type A, and the estimated value of the amount of black toner consumed in two years is closest to the amount of toner of type C. Note that a cartridge of type G is selected in a case where the estimated value of the amount of toner consumed in the contract period is larger than the amount of toner contained in a cartridge of type G due to a long contract period or a large number of contracted sheets.

The amounts of consumed toners that are used to generate determination information can be estimated based on, for example, an average amount of consumption among a plurality of users. For example, the amounts of consumed toners can be estimated based on an average amount of consumption among a plurality of users with the same number of contracted sheets. Also, for example, the amounts of consumed toners can be estimated based on an average amount of consumption among a plurality of users with the same number of contracted sheets and the same contract period. Moreover, an average amount of consumed toner per sheet in color printing and monochrome printing can be estimated based on the amounts of consumption by a plurality of users, and determination information can be generated based on this average amount of consumed toner per sheet.

Normally, cartridges 70 are filled with the maximum amount of toner and provided to the user. That is to say, cartridges 70 of type G according to the present embodiment are provided to the user. In the present embodiment, cartridges 70 with various toner amounts are provided to the user in accordance with the content of the service contract. For example, in the case of a user with a short contract period or a small number of contracted sheets, if cartridges 70 of type G are provided, unused toner remains in the cartridges 70 at the end of the contract. In the present embodiment, the amounts of toners remaining in cartridges 70 at the end of the contract can be reduced by deciding the types, namely, the toner amounts of cartridges 70 to be provided to the user in accordance with the content of the service contract. Also, in the case of a user with a long contract period or a large number of contracted sheets, the number of times cartridges 70 are delivered to the user can be reduced and the delivery cost can be lowered by increasing the amounts of provided toners.

Note that it is possible to adopt a configuration in which a plurality of cartridges 70 are provided to a user at a time in a case where it is determined that a cartridge 70 needs to be exchanged once or more until the end of the service contract due to a long contract period or a large number of contracted sheets, even if the cartridge is of type G.

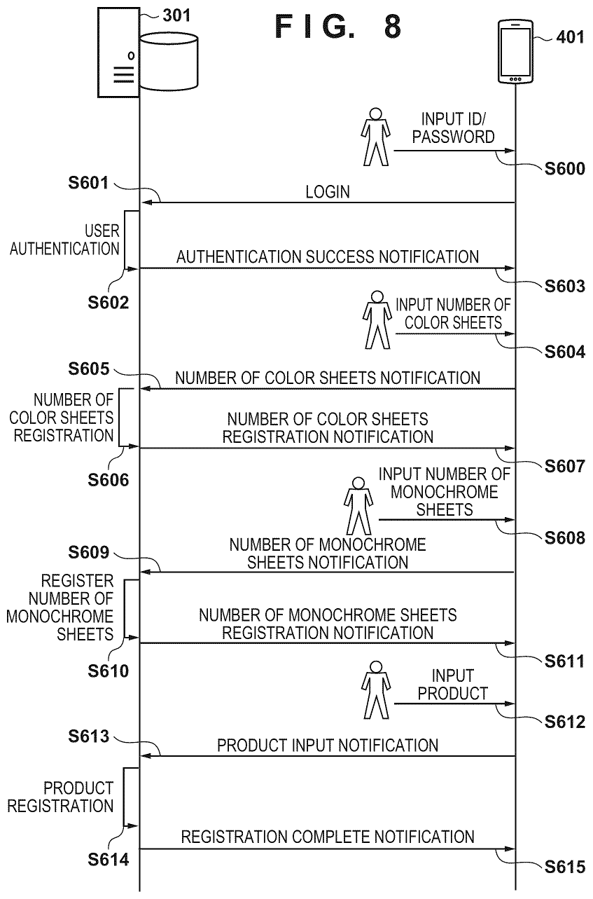

FIG. 8 is a sequence diagram showing an example of registration processing by a user. Note, it is assumed that, prior to the start of the sequence shown in FIG. 8, account information of the user has already been registered with the account table 320 of the management server 301. In step S600, the user terminal 401 displays a login screen, and accepts inputs of a user ID and a password from a user via this login screen. In step S601, the user terminal 401 transmits a login request, which includes the input user ID and password, to the management server 301.

In step S602, the management server 301 (authentication unit 380) executes user authentication based on the user ID and password received from the user terminal 401. It is assumed here that the user authentication has succeeded and the login to the management system 300 has been established. In step S603, the management server 301 transmits, to the user terminal 401, an authentication success notification indicating that the user authentication has succeeded as a response to the login request. Subsequent processing in the sequence shown in FIG. 8 is executed while the login session of the user (the user terminal 401) is continuing.

In step S604, the user terminal 401 accepts an input of the number of sheets contracted for color from the user via an input screen for the number of sheets contracted for color. After completion of the input of the number of sheets contracted for color, the user terminal 401 transmits information of the input number of sheets contracted for color to the management server 301 in step S605. Upon receiving the information of the number of sheets contracted for color from the user terminal 401, the management server 301 (registration processing unit 370) stores the number of contracted sheets under the “number of sheets contracted for color” in the account table 320 in step S606. Thereafter, in step S607, the management server 301 (registration processing unit 370) transmits a notification indicating that the number of sheets contracted for color has been registered to the user terminal 401. In this way, the registration of the number of sheets contracted for color is completed.

In step S608, the user terminal 401 accepts an input of the number of sheets contracted for monochrome from the user via an input screen for the number of sheets contracted for monochrome. After completion of the input of the number of sheets contracted for monochrome, the user terminal 401 transmits information of the input number of sheets contracted for monochrome to the management server 301 in step S609. Upon receiving the information of the number of sheets contracted for monochrome from the user terminal 401, the management server 301 (registration processing unit 370) stores the number of contracted sheets under the “number of sheets contracted for monochrome” in the account table 320 in step S610. Thereafter, in step S611, the management server 301 (registration processing unit 370) transmits a notification indicating that the number of sheets contracted for monochrome has been registered to the user terminal 401. In this way, the registration of the information of the number of sheets contracted for monochrome is completed.

In step S612, the user terminal 401 accepts an input of a product (an image forming apparatus) to be registered from the user via an input screen for a product type. After completion of the input of the product type, the user terminal 401 transmits information of the input product type to the management server 301 in step S613. Upon receiving the information of the product type from the user terminal 401, the management server 301 (registration processing unit 370) registers information of the image forming apparatus 1 with the apparatus registration table 330 in step S614, and transmits a notification indicating that the information of the product type has been registered to the user terminal 401 in step S615. In this way, the registration of the information of the product type is completed.

Also, based on the initial registration of the number of contracted sheets, the management unit 350 determines that starter cartridges are to be provided to the user. In this case, the selection unit 360 determines the types of the starter cartridges to be provided to the user based on the number of sheets contracted for color registered in step S606, and on the number of sheets contracted for monochrome registered in step S610. Also, the registration processing unit 370 registers information related to the starter cartridges selected by the selection unit 360 with the printing data table 340.

Note that the management unit 350 can also present the types of the starter cartridges selected by the selection unit 360 to the user in the sequence of FIG. 8. In this case, it is possible to adopt a configuration in which the starter cartridges of the selected types are provided to the user in response to a permission from the user. Note that it is possible to adopt a configuration that, in a case where the user does not give permission, causes the user to select a starter cartridge from a group of other types of cartridges with capacities that are different from the capacity of the selected type by a predetermined value or less.

### Second Embodiment

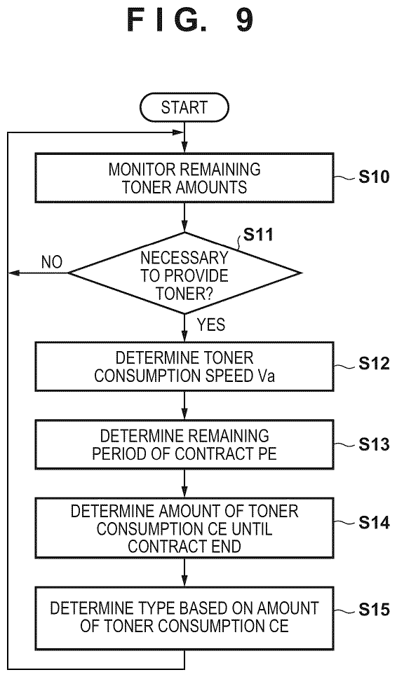

The first embodiment has been described in relation to selection of types of starter cartridges. The present embodiment will be described in relation to selection of types of exchange cartridges. FIG. 9 is a flowchart of processing executed by the management server 301 during a period of a service contract. Note, it is assumed that the management server 301 repeatedly obtains information related to the remaining amounts of toners in toner container units 53a or cartridges 70 in an image forming apparatus 1 from the image forming apparatus 1 via the network N2. It is also assumed that the registration processing unit 370 records the remaining amounts of toners of respective colors, which have been repeatedly obtained, into the printing data table 340 as history information. Note that it is possible to adopt a configuration in which only the current remaining toner amounts are stored in the printing data table 340, and the history information is stored in another table or another apparatus that can communicate with the management server 301.

In step S10, the management unit 350 monitors the remaining amounts of toners of respective colors in the image forming apparatus 1. This monitoring can be performed by monitoring the remaining toner amounts obtained from the image forming apparatus 1, or by monitoring the history information of the printing data table 340. In step S11, the management unit 350 determines whether there is toner that should be provided (delivered) to a user by determining whether there is toner with a remaining toner amount that satisfies a first provision condition (first condition). For example, the first provision condition is satisfied when the remaining toner amount has become smaller than a first threshold, which is larger than 0, or has become equal to or smaller than the first threshold. Also, for example, the first provision condition is satisfied when the remaining toner amount has reached 0. In a case where none of the remaining amounts of toners of respective colors satisfies the first provision condition, the management unit 350 determines that it is not necessary to provide toners, that is to say, it is not necessary to deliver exchange cartridges 70.

In a case where the management unit 350 has determined that toner needs to be provided, the selection unit 360 determines a toner consumption speed Va (a first consumption speed) of toner of the color to be provided (a first color material) in step S12. The toner consumption speed Va is an amount of toner consumption per unit period, and can be determined from the history information. Subsequently, in step S13, the selection unit 360 determines a remaining period of contract PE, which is a period until the timing of the end of the contract. In step S14, the selection unit 360 determines an amount of toner consumption CE in the remaining period of contract PE (a first consumption amount). The amount of toner consumption CE is calculated based on a product of the remaining period of contract PE and the toner consumption speed Va. For example, the amount of toner consumption CE is calculated by CE=PE×Va. Alternatively, the amount of toner consumption CE can also be obtained by adding a predetermined amount of margin to Va×PE. With this configuration, the probability that toner is depleted near the end of the service contract can be lowered.

In step S15, the selection unit 360 determines the type of the cartridge 70 to be provided to the user based on the amount of toner consumption CE. Specifically, the selection unit 360 calculates a determination amount based on the amount of toner consumption CE. The determination amount is calculated by, for example, subtracting the remaining toner amount from the amount of toner consumption CE. The selection unit 360 compares the determination amount with a plurality of capacities of seven types of cartridges 70. Then, in a case where the determination amount is larger than the maximum amount among the plurality of capacities, the selection unit 360 regards the maximum amount as a provision amount (a first provision amount) for the user. Otherwise, that is to say, in a case where the determination amount is equal to or smaller than the maximum amount, the selection unit 360 regards a capacity which is equal to or larger than the determination amount and which is closest to the determination amount as a provision amount (a first provision amount). Then, the selection unit 360 determines that a cartridge 70 of a type containing the provision amount is to be provided to the user. For example, when a relative value of the determination amount is 0.6, a cartridge 70 of type E is selected as the exchange cartridge. Also, when the relative value of the determination amount is larger than 1, a cartridge 70 of type G is selected as the exchange cartridge. Note that it is also possible to regard the amount of toner consumption CE as the determination amount, rather than regarding the result of subtracting the remaining toner amount from the amount of toner consumption CE as the determination amount.

Note that it is possible to adopt a configuration in which, in a case where the remaining period of contract PE is shorter than a predetermined period, the management unit 350 transmits, to the user terminal 401, a message for confirming with the user whether to extend the contract after step S13. In response to this message, the user can transmit a notification indicating whether to extend the contract period, and a period of extension in a case where the extension is to be made, to the management server 301 via the user terminal 401. The management unit 350 causes processing to proceed to step S14 in a case where a message indicating that the contract period is not to be extended has been received from the user terminal, and in a case where a response message has not been received from the user terminal within a predetermined period. On the other hand, in a case where a message indicating that the contract period is to be extended has been received from the user terminal together with the period of extension, the registration processing unit 370 updates the account table 320. Also, the selection unit 360 executes processing of step S14 onward based on the updated remaining period of contract PE.

As described above, in a case where it has been determined that a first color material is to be provided to a user, a first consumption amount that is an amount of toner consumption of the first color material until a first timing is determined, and a first provision amount that is an amount of the first color material to be provided to the user, that is to say, a type of a cartridge, is determined based on the first consumption amount. Note that in the present embodiment, the first timing is the timing of the end of the contract. With this configuration, an amount of the first color material remaining in a cartridge 70 at the timing of the end of the service contract can be reduced. Also, the number of times cartridges 70 are delivered to the user can be reduced and the delivery cost can be lowered by determining the first provision amount of the first color material for the user based on the first consumption amount.

In the present embodiment, a toner consumption speed Va of a user is determined based on history information of this user, and an amount of toner consumption CE of this user is accordingly determined in step S14. Here, a period of the history information used in calculation of the toner consumption speed Va may be an entire period of the history information, or may be a predetermined period thereof in the past. Furthermore, the period of the history information used in calculation of the toner consumption speed Va may also be a period of use of a cartridge 70 to be exchanged. In addition, it is possible to adopt a configuration in which the toner consumption speeds of other users are also taken into consideration in calculation of the toner consumption speed Va. That is to say, it is possible to adopt a configuration in which pieces of history information in one or more image forming apparatuses used by other uses are used in determination of the toner consumption speed Va. Here, other users can be, for example, other users with the same number of contracted sheets.

Furthermore, types of exchange cartridges can also be decided based on the determination information shown in FIG. 7, which has been used to determine types of starter cartridges. In this case, calculation of the toner consumption speed Va is unnecessary, and determination information corresponding to a contract period that is the same as the remaining period of contract PE, or determination information corresponding to a contract period closest to the remaining period of contract PE, is used.

Also, in the present embodiment, the management server 301 repeatedly obtains the remaining toner amounts from an image forming apparatus 1. However, it is also possible to adopt a configuration in which the image forming apparatus 1 monitors the remaining toner amounts, and when a remaining toner amount has reached a threshold at which a cartridge 70 needs to be exchanged, the image forming apparatus 1 notifies the management server 301 of the necessity to exchange the cartridge 70, that is to say, satisfaction of the first provision condition. Furthermore, with regard to exchange cartridges as well, it is possible to adopt a configuration in which a user is notified in advance of the type selected in step S15 and a permission is obtained, similarly to starter cartridges. Similarly to starter cartridges, it is possible to adopt a configuration that, in a case where the user does not give permission, causes the user to select exchange cartridges from a group of types of cartridges with capacities that are different from the capacity of the selected type by a predetermined value or less.

### Third Embodiment

In the second embodiment, when there is a cartridge 70 with a remaining toner amount that satisfies the first provision condition, the service provider provides (delivers) an exchange cartridge that has the same color as this cartridge 70 to a user. However, in a case where a second-color cartridge 70 is also expected to be in a state where it satisfies the first provision condition in the near future in a state where a remaining toner amount of a first-color cartridge 70 satisfies the first provision condition, the delivery cost can be suppressed by delivering both of first-color and second-color exchange cartridges collectively to a user.

In view of this, a second provision condition (a second condition) is provided in the present embodiment. For example, in a case where the first provision condition is satisfied when a remaining toner amount has become smaller than the first threshold or become equal to or smaller than the first threshold, the second provision condition is satisfied when the remaining toner amount has become smaller than a second threshold, which is larger than the first threshold, or become equal to or smaller than the second threshold. Also, in a case where the first provision condition is satisfied when a remaining toner amount has reached 0, the second provision condition is satisfied when the remaining toner amount has become smaller than a second threshold, which is larger than 0, or become equal to or smaller than the second threshold. The second provision condition is a condition for, in a case where there is a first color material that satisfies the first provision condition, determining a second color material that does not satisfy the first provision condition but is to be delivered to a user together with the first color material.

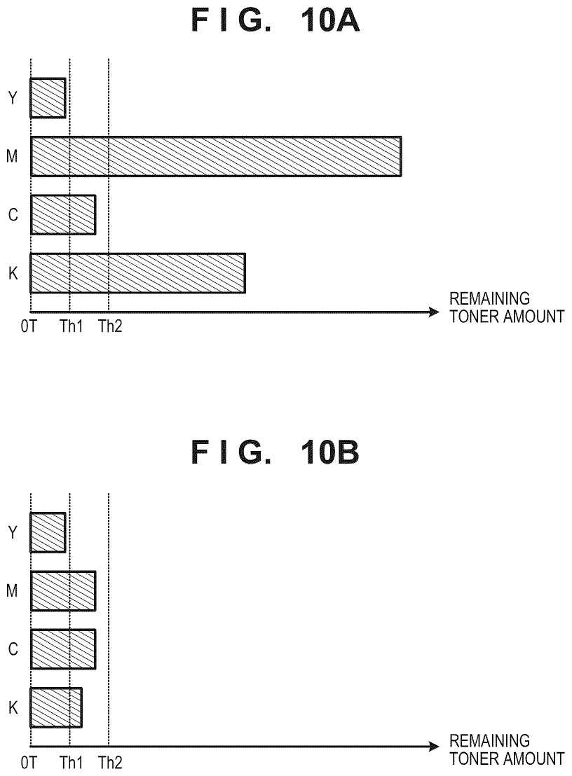

For example, assume that remaining amounts of toners of yellow (Y), magenta (M), cyan (C), and black (K) are as shown in FIG. 10A. Note that in FIG. 10A, Th1 is a first threshold and Th2 is a second threshold. In FIG. 10A, the remaining amount of Y toner falls below the first threshold. Also, the remaining amount of C toner is larger than the first threshold, but is smaller than the second threshold. Note that the remaining amounts of M and K toners are both larger than the second threshold. In the second embodiment, in the case of the state of FIG. 10A, only a cartridge 70 of Y (first color material) is delivered to the user. On the other hand, in the present embodiment, a cartridge 70 of C (the second color material) is delivered to the user, in addition to a cartridge 70 of Y (the first color material). In this way, the number of times cartridges 70 are delivered can be reduced. Note that a method of determining a type of the cartridge 70 of C, which is the second color material, is similar to that according to the second embodiment. That is to say, the selection unit 360 (the second determination unit) determines a second consumption amount of the second color material until the timing of the end of the contract (the first timing), and determines a second provision amount, that is to say, a type of the cartridge 70 of the second color material, based on the second consumption amount.

### Fourth Embodiment

Subsequently, a fourth embodiment will be described with a focus on differences from the third embodiment. In the present embodiment, too, toner to be provided to a user is determined based on the first provision condition and the second provision condition, similarly to the third embodiment. However, in the present embodiment, a toner provision amount is not determined individually on a per-color basis, but is determined based on the remaining amounts of toners of all four colors used in image formation.

In the case of the state shown in FIG. 10A, the management server 301 determines that toners of Y and C are to be provided to the user, similarly to the third embodiment. On the other hand, in the case of the state shown in FIG. 10B, the management server 301 determines that toners of Y, M, C, and K, that is to say, all colors, are to be provided to the user. In the following description, a cartridge 70 to be provided (delivered) to the user will be referred to as a provided cartridge, and toner to be provided (delivered) thereto will be referred to as provided toner (a first color material and a second color material). Furthermore, a cartridge 70 that is not to be provided will be referred to as an unprovided cartridge, and toner that is not to be provided will be referred to as unprovided toner (a third color material). In the case of FIG. 10A, provided cartridges are cartridges 70 of Y and C, provided toners are toners of Y and C, unprovided cartridges are cartridges 70 of M and K, and unprovided toners are toners of M and K. Similarly, in the case of FIG. 10B, provided cartridges are cartridges 70 of all colors, provided toners are toners of all colors, and neither unprovided cartridges nor unprovided toners exist.

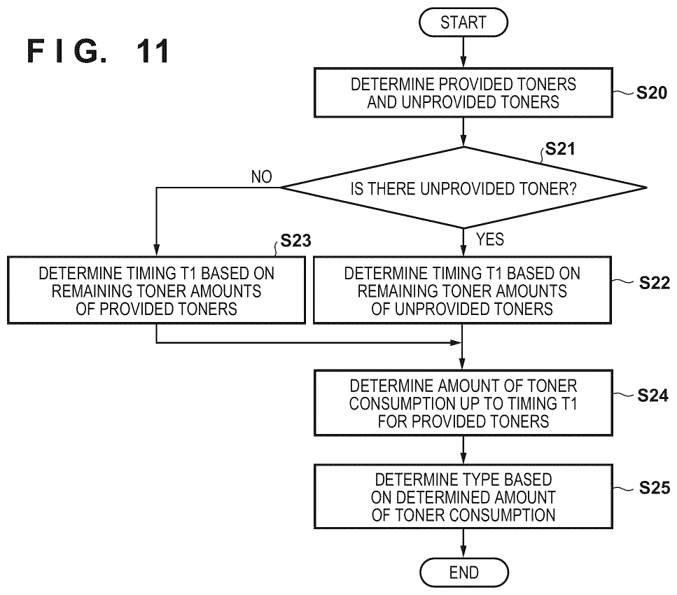

FIG. 11 is a flowchart of processing for determining a type of a provided cartridge, that is to say, a provision amount of provided toner. Processing of FIG. 11 is started upon entering a state where a remaining amount of toner of at least one color satisfies the first provision condition. Note, it is assumed that the respective toner consumption speeds of Y, M, C, and K have been calculated as described in the second embodiment.

In step S20, the management unit 350 determines provided toners and unprovided toners. As stated earlier, provided toners are toners that satisfy the first provision condition and toners that satisfy the second provision condition. In step S21, the selection unit 360 determines whether unprovided toners (the third color materials) are present. For example, the unprovided toners are “present” in the case of FIG. 10A, and the unprovided toners are “absent” in the case of FIG. 10B.

In a case where the unprovided toners are present, the selection unit 360 determines a timing TE (a second timing) at which a remaining toner amount reaches a third threshold for each unprovided toner. The third threshold is a predetermined amount, and is selected from within a range of remaining toner amounts that satisfy the first provision condition. For example, provided that the third threshold is 0 and the toner consumption speed of unprovided toner is a second consumption speed, the timing TE is calculated by (the remaining amount of unprovided toner/the second consumption speed). In a case where only toner of one color is unprovided toner, the selection unit 360 regards the timing TE of this unprovided toner as a timing T1. Also, in a case where toners of a plurality of colors are unprovided toners, the selection unit 360 regards one of the timings TE of the respective unprovided toners as the timing T1. For example, the selection unit 360 can regard the latest timing among the timings TE of the respective unprovided toners as the timing T1. For example, in FIG. 10A, the unprovided toners are M and K toners. The selection unit 360 determines the timing TE of M based on the remaining amount of M toner and on the speed of consumption of M toner. Similarly, the selection unit 360 determines the timing TE of K based on the remaining amount of K toner and on the speed of consumption of K toner. The selection unit 360 regards one of the timing TE of M and the timing TE of K as the timing T1. For example, the selection unit 360 can regard a later one of the timing TE of M and the timing TE of K as the timing T1 (first timing). Note that in a case where the timing T1 is after the timing of the end of the contract, the timing of the end of the contract can be regarded as the timing T1 (first timing).

In step S24, the selection unit 360 determines the amount of toner consumption until the timing T1 for each provided toner. The amount of toner consumption can be calculated based on a product of a period until the timing T1 and the toner consumption speed. In the case of FIG. 10A, the selection unit 360 determines each of the amount of consumption of Y toner and the amount of consumption of C toner until the timing T1. In step S25, the selection unit 360 determines a provision amount of each provided toner based on the determined amounts of toner consumption, similarly to step S15 of FIG. 9, thereby determining the types of provided cartridges.

Through processing of steps S22, S24, and S25, toners of respective colors can be provided at the same time. For example, assume that the timing TE at which the remaining amount of toner of M reaches the third threshold is the timing T1 in the example of FIG. 10A. In this case, the remaining toner amounts of the cartridges 70 of Y, M, and C satisfy the first provision condition substantially at the same timing. Therefore, the cartridges 70 of Y, M, and C can be collectively delivered to the user. Furthermore, at the next timing, the cartridges 70 of all colors, namely Y, M, C, and K, can be collectively delivered to the user. In this way, the delivery cost can be suppressed.

On the other hand, in a case where unprovided toner is absent in step S21, the selection unit 360 determines the timing T1 based on the remaining toner amounts of the respective provided toners. Specifically, it determines the timing TE (third timing) at which a remaining toner amount reaches the third threshold next in a case where a capacity of type G, that is to say, the maximum amount of toner is provided to the user. As stated earlier, the third threshold is selected from within a range of remaining toner amounts that satisfy the first provision condition. The timing TE is calculated by dividing a sum of the current remaining toner amount and the capacity of type G by the toner consumption speed. The selection unit 360 regards the earliest one of the timings TE of the respective provided toners as a timing T2. In a case where the timing T2 is after the timing of the end of the contract, which is a predetermined timing, the timing of the end of the contract is regarded as the timing T1 (first timing). On the other hand, in a case where the timing T2 precedes the timing of the end of the contract, the selection unit 360 regards the timing T2 as the timing T1 (first timing). Then, the selection unit 360 determines a type of each provided cartridge based on the timing T1 through processing of steps S24 and S25.

Processing of step S23 is executed in a case where the cartridges 70 of all colors are the provided cartridges as shown in FIG. 10B. Therefore, through processing of steps S23, S24, and S25, the remaining toner amounts of all cartridges 70 satisfy the first provision condition substantially at the same timing. Note that in a case where the timing T2 is after the timing of the end of the contract, the remaining toner amounts of all cartridges 70 satisfy the first provision condition near the timing of the end of the contract. On the other hand, in a case where the timing T2 precedes the timing of the end of the contract, the remaining toner amounts of all cartridges 70 satisfy the first provision condition near the timing T2. In this case, four cartridges 70 can be collectively delivered, and the delivery cost can be suppressed.

### Others

An image forming apparatus 1 according to each of the above-described embodiments forms an image with cartridges 70 attached thereto, and toner is fed to the image forming apparatus 1 by exchanging the cartridges 70. However, each of the above-described embodiments is also applicable to an image forming apparatus 100 of a method in which a development unit is provided with a reservoir unit for toner, and toner is fed from a feeding pack, which is another container member, to the reservoir unit of the development unit.

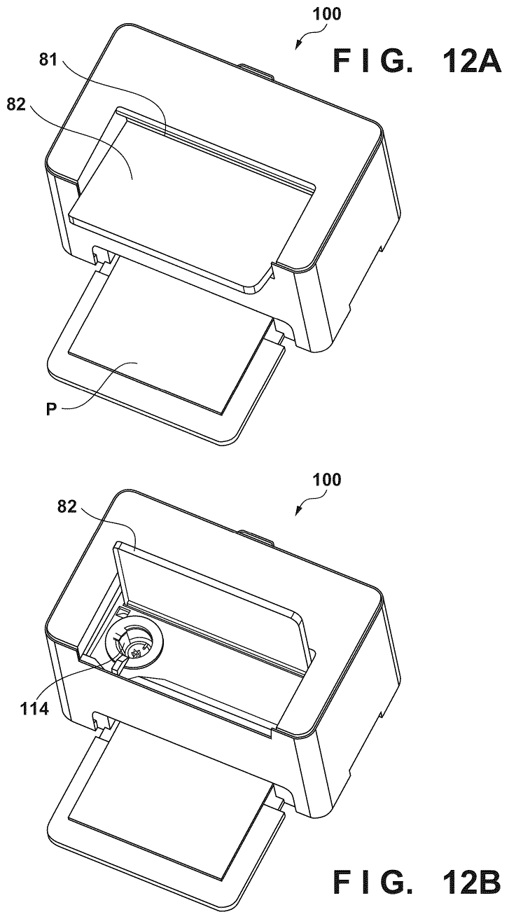

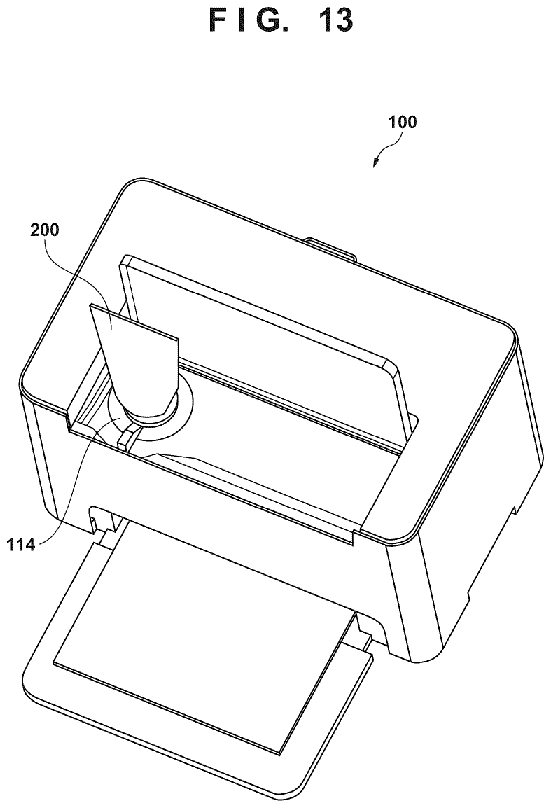

FIG. 12A is a perspective view of the image forming apparatus 100 of the method in which toner is fed from a feeding pack, rather than from a cartridge 70. A sheet P on which an image is to be formed is fed to the inside of the image forming apparatus 100, and is discharged onto a discharge tray 82 from a discharge opening 81 after the image has been formed thereon. In FIG. 12A, the discharge tray 82 is in a closed state. FIG. 12B is a diagram of the discharge tray 82 in an open state. The image forming apparatus 100 is configured so that a feed opening 114 for toner is exposed in this state. The reservoir unit of the development unit is situated below the feed opening 114. As shown in FIG. 13, K toner from a feeding pack 200 can be supplied to the reservoir unit of the development unit via the feed opening 114.

Note that the image forming apparatus 100 according to the present embodiment is capable of performing monochrome printing only; therefore, the management DB 313 manages only information related to monochrome printing, such as the number of sheets contracted for monochrome, and does not need to manage information related to color printing. Also, in the case of the image forming apparatus 100, the printing data table 340 manages “reservoir unit information” in place of “cartridge information” described in the first embodiment. The “reservoir unit information” indicates the current remaining toner amount inside the reservoir unit. Furthermore, the “reservoir unit information” can indicate, for example, a history of remaining toner amounts for calculating a toner consumption speed.

In the case of the image forming apparatus 100, types of cartridges 70 described in each of the above embodiments are types of the feeding pack 200. The types of the feeding pack 200 are distinguished in accordance with the amounts of toner stored in the feeding pack 200. Note that it is permissible to adopt a configuration in which the feeding pack 200 is filled with a necessary amount of toner and provided to a user, rather than setting a predetermined number of types in advance. For example, according to the description of the second embodiment, the determination amount is calculated based on the amount of toner consumption CE in step S15 of FIG. 9, and the selection unit 360 regards one of the capacities of type A to type G as a provision amount by comparing the determination amount with the capacities of type A to type G. In a case where the image forming apparatus 100 is used, it is possible to adopt a configuration in which the feeding pack 200 is filled with toner of the determination amount and provided to the user. Note that it is possible to use a feeding pack 200 that comes in a variety of sizes with different maximum containable amounts, unlike cartridges 70. It is possible to adopt a configuration in which, in a case where the determination amount exceeds the maximum containable amount of a feeding pack 200 of the largest size, this feeding pack 200 is filled with the maximum amount of toner and provided to the user.

Although the image forming apparatus 100 of FIG. 12 is capable of performing only monochrome printing, the image forming apparatus 100 may be capable of performing color printing. In this case, the image forming apparatus 100 is configured to be capable of supplying Y, M, C, and K toners to reservoir units of development units of respective colors via feed openings 114 for respective colors. Conversely, an image forming apparatus 1 according to each of the above-described embodiments may be a monochrome image forming apparatus capable of using only a cartridge 70 of K.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A server apparatus that manages an image forming apparatus that forms an image on sheets using a color material, the server apparatus comprising:
one or more processors configured to
in a case where a remaining amount of the color material included in the image forming apparatus satisfies a first condition, determine that the color material is to be provided to a user of the image forming apparatus, and
in a case where it has been determined that a first color material is to be provided to the user, determine a first consumption amount of the first color material until a first timing, and determine a first provision amount of the first color material to be provided to the user, based on the first consumption amount.

2. The server apparatus according to claim 1, wherein
the first condition is satisfied when the remaining amount of the color material has reached 0, or when the remaining amount of the color material has become smaller than a first threshold.

3. The server apparatus according to claim 1, wherein
the one or more processors are further configured to receive, from the image forming apparatus, a notification indicating that the remaining amount of the color material satisfies the first condition.

4. The server apparatus according to claim 1, wherein
the first timing is a predetermined timing.

5. The server apparatus according to claim 1, wherein
the one or more processors are further configured to determine the first consumption amount, based on a first consumption speed of the first color material, and on a period until the first timing.

6. The server apparatus according to claim 5, wherein
the one or more processors are further configured to determine the first consumption speed, based on a history of remaining amounts of the first color material in the image forming apparatus.

7. The server apparatus according to claim 6, wherein
the one or more processors are further configured to, in order to determine the first consumption speed, use a history of remaining amounts of the first color material in one or more other image forming apparatuses different from the image forming apparatus.

8. The server apparatus according to claim 1, wherein
the one or more processors are further configured to determine the first consumption amount, based on a number of contracted sheets that is based on a contract with the user, and on a period until the first timing, and
the number of contracted sheets indicates a number of the sheets on which the image is formable using the first color material per unit period under the contract.

9. The server apparatus according to claim 8, wherein
the one or more processors are further configured to determine, based on a contract period of the contract and the number of contracted sheets, a provision amount of the color material that is provided to the user at first based on the contract.

10. The server apparatus according to claim 1, wherein
the one or more processors are further configured to select a maximum amount among a plurality of different color material amounts that have been decided in advance as the first provision amount in a case where a determination amount that is based on the first consumption amount is larger than the maximum amount, and select a color material amount that is equal to or larger than the determination amount and is closest to the determination amount as the first provision amount from among the plurality of color material amounts in other cases.

11. The server apparatus according to claim 10, wherein
the determination amount is based on an amount obtained by subtracting a remaining amount of the first color material from the first consumption amount.

12. The server apparatus according to claim 1, wherein
the first provision amount is the first consumption amount, or an amount obtained by subtracting a remaining amount of the first color material from the first consumption amount.

13. The server apparatus according to claim 10, wherein
the image forming apparatus forms the image on the sheets with a container member stored in a body thereof, the container member containing the first color material, and
each of the plurality of color material amounts is equal to or smaller than a containable amount of the container member.

14. The server apparatus according to claim 10, wherein
the image forming apparatus forms the image on the sheets using the first color material that has been fed from a container member that contains the first color material to a container unit of the image forming apparatus, and
each of the plurality of color material amounts is equal to or smaller than a containable amount of the container member.

15. The server apparatus according to claim 1, wherein
the image forming apparatus uses a plurality of color materials including the first color material to form the image on the sheets, and
the one or more processors are further configured to
in a case where a remaining amount of the first color material satisfies the first condition, determine whether a remaining amount of a color material which is included among the plurality of color materials and which is different from the first color material satisfies a second condition, and determine that a second color material with the remaining amount that satisfies the second condition is to be provided to the user, and
in a case where it has been determined that the second color material is to be provided to the user, determine a second consumption amount of the second color material until the first timing, and determine a second provision amount of the second color material to be provided to the user, based on the second consumption amount.

16. The server apparatus according to claim 15, wherein
the first condition is satisfied when the remaining amount has reached 0, and the second condition is satisfied when the remaining amount has become smaller than a second threshold that is larger than 0, or
the first condition is satisfied when the remaining amount has become smaller than a first threshold, and the second condition is satisfied when the remaining amount has become smaller than a second threshold that is larger than the first threshold.

17. The server apparatus according to claim 15, wherein
the one or more processors are further configured to, in a case where a third color material that does not satisfy the second condition is present among the plurality of color materials, determine a second timing at which a remaining amount of the third color material reaches a predetermined amount within a range that satisfies the first condition, and determine the first timing based on the second timing, and
the second timing is determined based on the remaining amount of the third color material, and on a second consumption speed of the third color material.

18. The server apparatus according to claim 17, wherein
the one or more processors are further configured to, in a case where there are a plurality of third color materials that do not satisfy the second condition, determine the second timing for each of the plurality of third color materials, and determine the first timing based on a latest timing among the second timings of the respective plurality of third color materials.

19. The server apparatus according to claim 18, wherein
the one or more processors are further configured to determine that a predetermined timing is the first timing in a case where the latest timing among the second timings of the respective plurality of third color materials is after the predetermined timing, and determine that the latest timing among the second timings of the respective plurality of third color materials is the first timing in other cases.

20. The server apparatus according to claim 15, wherein
the one or more processors are further configured to, in a case where remaining amounts of all color materials which are included among the plurality of color materials and which are different from the first color material satisfy the second condition, determine, for each of the plurality of color materials, a third timing at which the remaining amount reaches a predetermined amount within a range that satisfies the first condition after providing the image forming apparatus with a maximum amount among a plurality of different color material amounts that have been decided in advance, and determine the first timing based on an earliest timing among the third timings of the respective plurality of color materials, and
the third timing of the color material is determined based on the remaining amount of the color material, and on a consumption speed of the color material.

21. The server apparatus according to claim 20, wherein
the one or more processors are further configured to determine that a predetermined timing is the first timing in a case where the earliest timing among the third timings of the respective plurality of color materials is after the predetermined timing, and determine that the earliest timing among the third timings of the respective plurality of color materials is the first timing in other cases.

22. A non-transitory computer-readable storage medium storing a computer program that, when executed by one or more processors included in an apparatus, causes the apparatus to:
in a case where a remaining amount of a color material included in an image forming apparatus that forms an image on sheets using the color material satisfies a first condition, determine that the color material is to be provided to a user of the image forming apparatus, and
in a case where it has been determined that a first color material is to be provided to the user, determine a first consumption amount of the first color material until a first timing, and determine a first provision amount of the first color material to be provided to the user, based on the first consumption amount.

23. A management system, comprising:
an image forming apparatus that forms an image on sheets using a color material; and
a server apparatus configured to be capable of communicating with the image forming apparatus,
wherein in a case where a remaining amount of the color material included in the image forming apparatus satisfies a first condition, the server apparatus determines that the color material is to be provided to a user of the image forming apparatus, and in a case where it has been determined that a first color material is to be provided to the user, the server apparatus determines a first consumption amount of the first color material until a first timing, and determines a first provision amount of the first color material to be provided to the user, based on the first consumption amount.
